(19) United States
(12) Patent Application Publication
(10) Pub. No.: US 2026/0291160 A1
(43) Pub. Date: Sep. 24, 2026

(54) CABLE FASTENING SYSTEM AND CABLE FASTENING METHOD USING SAME

(71) Applicant: LG ELECTRONICS INC., Seoul (KR)

(72) Inventors: Taeyoung CHOI, Seoul (KR); Sungeun CHUNG, Seoul (KR); Yunsoo KIM, Seoul (KR); Gwanwoo KIM, Seoul (KR); Cheoljun PAIK, Seoul (KR)

(73) Assignee: LG ELECTRONICS INC., Seoul (KR)

(21) Appl. No.: 19/490,219

(22) PCT Filed: Jun. 8, 2023
(86) PCT No.: PCT/KR2023/007834

§ 371 Date: Dec. 4, 2025

(51) Int. Cl. H01R 43/26; B25J 9/16; B25J 15/06; B25J 19/02; H01R 12/79

(52) U.S. Cl. CPC H01R 43/26; B25J 9/1697; B25J 15/0616; B25J 19/023; H01R 12/79

(57) ABSTRACT

Provided is a cable fastening system comprising: a body; a grip portion which is located at the lower portion of the body and grips one end of a flat cable, where a connection portion is located; a robot arm which is coupled to the upper portion of the body and inserts the one end of the flat cable into a connector; and a control unit which controls the grip portion and the robot arm, wherein the robot arm inserts one side of the connection portion of the flat cable into the connector, slidably moves the flat cable toward the one side of the connection unit, and then rotates the body so that the connection portion of the flat cable and the connector are arranged in parallel.

### TECHNICAL FIELD

The present disclosure relates to a system for fastening a cable to a connector on a board and a cable fastening method using the same.

### BACKGROUND

Most electronic devices and home appliances, such as flat panel displays, computers, air conditioners, and washing machines, include a plurality of printed circuit boards. A printed circuit board may include multiple devices, and devices such as a camera, a display panel, a speaker, a wireless communication unit, various sensors, and a battery may be connected to the printed circuit board.

A cable such as a flexible printed circuit (FPC) or a flexible flat cable (FFC) may be used to connect printed circuit boards to each other or to connect other electronic devices to a printed circuit board.

A connector for connection to other electronic devices is formed on a printed circuit board 10, and a cable such as a flexible printed circuit (FPC) or a flexible flat cable (FFC) may be inserted into a connector 12, and a latch is formed on the connector to fix and connect the inserted cable.

After the cable is fully inserted into the connector of the printed circuit board, the latch may be pressed to fix the inserted cable to the connector.

The method of fastening the connector of such a cable is performed manually or even using a robot, but it is difficult to stably fasten the flexible cable to the connector.

When a robot is used, there is difficulty in holding the cable. The method the cable is held on both sides may cause the flexible cable to bend depending on the strength of the force, making it difficult to insert into the connector.

Flexible printed circuits or flexible flat cables are flat cables, and when held from both sides, the shape change of the cable may be minimized. However, the robot may need to repeat an operation of inserting the cable into the connector multiple times to insert the cable into the correct connector. This will take a long time and may damage the connector.

### DISCLOSURE

### Technical Problem

An object of the present disclosure is to provide a system for accurately and quickly fastening a cable to a connector on a board and a cable fastening method using the same to resolve the above-mentioned problem.

The problems to be solved in the present disclosure are not limited by the above mentioned technical problems, and other unmentioned technical problems can be clearly understood from the above description by those having ordinary skill in the technical field to which the present disclosure pertains.

### Technical Solution

A cable fastening system includes a body, a gripper located at a lower portion of the body and gripping one end at which a connection portion of a flat cable is located, a robot arm coupled to an upper side of the body and inserting one end of the flat cable into a connector, and a controller configured to control the gripper and the robot arm, and the robot arm inserts one side of the connection portion of the flat cable into the connector, slide the flat cable in a direction of one side of the connection portion, and then rotate the body such that the connection portion of the flat cable and the connector are arranged parallel to each other.

The gripper may include a pair of side grippers that have a gap that narrows in right and left directions of the flat cable and grip the flat cable, and the pair of side grippers may include a side wall portion positioned laterally of the flat cable, and an upper surface portion extending vertically from an upper portion of the side wall portion and in contact with an upper surface of the flat cable.

The pair of side grippers may include a first inclined guide positioned on an upper portion of the side wall portion and extending toward the opposing side gripper.

The flat cable may include a step portion having a width that increases in another-end direction from the connection portion, and the pair of side grippers may include a front portion having an accommodation groove extending vertically from a front of the side wall portion and in contact with the step portion, and a second inclined guide extending toward the flat cable from a front of the accommodation groove.

The flat cable may include a cable holder extending in another-end direction from the connection portion, and a rear gripper inserted between the cable holder and the flat cable such that the step portion of the flat cable is inserted into the accommodation groove may be provided.

The gripper may include a suction pickup device that provides negative pressure to suck the flat cable.

The gripper may include a linear motor that drives the suction pickup device up and down.

The cable fastening system may further include a first camera positioned on the body and configured to photograph the gripper, and the controller may recognize a position of the connection portion of the flat cable based on an image captured by the first camera and control the robot arm such that the connection portion is inserted into the connector.

The flat cable may include a step portion having a width that increases in another-end direction from the connection portion, and a cable holder extending in the other-end direction from the connection portion, and the controller may recognize the connection portion of the flat cable, the step portion, and the cable holder by designating a corner of at least one of one end of the flat cable, the step portion and the cable holder as a key point.

Insertion of the flat cable into the connector may be performed normally when one of a straight line connecting key points of the step portion of the flat cable or a straight line connecting key points of the cable holder is parallel to the insertion portion of the connector.

The cable fastening system may further include a second camera configured to photograph the connector and detect a position of the insertion portion of the connector, and the controller may control the robot arm such that the connection portion of the flat cable is inserted into the insertion portion of the connector.

The cable fastening system may further include a linear stage configured to change a horizontal position of the second camera, and the controller may control the linear stage such that a horizontal center of the insertion portion is located at a center of a viewing angle of the second camera.

The cable fastening system may further include a drive link rotatably coupled to the body, a locking lever having an upper portion coupled to one end of the drive link and located in front of the gripper, and a lever driver that moves another end of the drive link, and during driving of the locking lever, a lower end of the locking lever pushes a locking device of the connector and presses the flat cable.

The cable fastening system may further include a guide link located at a lower portion of the drive link and located between the body and the locking lever, and the lower end of the locking lever may move in a parabolic shape.

The lever driver may include a link slot extending horizontally formed therein and a locking block moving vertically, and a link protrusion protruding from an upper end of the drive link may be inserted into the link slot and is changed in position within the link slot when the locking block moves.

### Advantageous Effects

The cable fastening system according to the present disclosure may quickly fasten a cable to a connector on a board.

The cable fastening system according to the present disclosure may have an advantage of improving the accuracy of cable fastening by identifying the exact fastening position through image analysis.

The cable fastening system according to the present disclosure may reduce failure of a cable to be fastened to the connector and prevent the connection portion of the cable from being damaged when the fastening fails.

Effects obtainable from the present disclosure are not limited by the above mentioned effects, and other unmentioned effects can be clearly understood from the above description by those having ordinary skill in the technical field to which the present disclosure pertains.

### BRIEF DESCRIPTION OF THE DRAWINGS

FIG. 1 is a block diagram for explaining a cable fastening system according to an embodiment of the present disclosure.

FIG. 2 is a diagram showing a cable fastening system according to an embodiment of the present disclosure.

FIG. 3 is a diagram showing a fastening robot of a cable fastening system according to an embodiment of the present disclosure.

FIG. 4 is a diagram for explaining a method of recognizing a flat cable and a connector of a cable fastening system according to an embodiment of the present disclosure.

FIG. 5 is a flowchart illustrating a cable fastening method according to an embodiment of the present disclosure.

FIG. 6 is a diagram illustrating a state in which a cable fastening system grips a cable according to an embodiment of the present disclosure.

FIG. 7 and FIG. 8 are diagrams illustrating a process in which a cable fastening system absorbs and grips a cable according to an embodiment of the present disclosure.

FIG. 9 is a diagram illustrating a lower end of a side gripper of a cable fastening system according to an embodiment of the present disclosure.

FIG. 10 and FIG. 11 are diagrams illustrating the operation of a side gripper of a cable fastening system according to an embodiment of the present disclosure.

FIG. 12 is a perspective view showing a state in which a flat cable is aligned to a side gripper of a cable fastening system according to an embodiment of the present disclosure.

FIG. 13 is a diagram illustrating the operation of a rear gripper of the cable fastening system according to an embodiment of the present disclosure.

FIG. 14 is a diagram showing a state in which a cable fastening system inserts a cable into a connector according to an embodiment of the present disclosure.

FIG. 15 is a diagram illustrating a process of inserting a flat cable of a cable fastening system into a connector according to an embodiment of the present disclosure.

FIG. 16 and FIG. 17 are diagrams illustrating the operation of a cable locking lever of a cable fastening system according to an embodiment of the present disclosure.

FIG. 18 is a diagram illustrating a method of evaluating a state in which a flat cable of a cable fastening system is fastened to a connector, according to an embodiment of the present disclosure.

### DETAILED DESCRIPTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element may be directly connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

A robot is a machine device capable of automatically performing a certain task or operation. The robot may be controlled by an external control device or may be embedded in the control device. The robot may perform tasks that are difficult for humans to perform, such as repeatedly processing only a preset operation, lifting a heavy object, performing precise tasks or a hard task in extreme environments.

In order to perform such tasks, the robot includes a driver such as an actuator or a motor, so that the robot may perform various physical operations, such as moving a robot joint. Industrial robots or medical robots having a specialized appearance for specific tasks due to problems such as high manufacturing costs and dexterity of robot manipulation were the first to be developed. Industrial and medical robots perform the same movements repeatedly in a designated location. However, even when performing the same task, robots equipped with artificial intelligence have emerged to recognize minute differences in precision work and apply these differences to perform optimized work.

Artificial intelligence (AI) technology is applied to the robot, so that the robot may be implemented as a guide robot, a transportation robot, a cleaning robot, a wearable robot, an entertainment robot, a pet robot, and an unmanned aerial robot, etc.

The robot may include a robot control module for controlling operation thereof, and the robot control module may refer to a software module or a chip implemented in hardware.

By means of sensor information obtained from various types of sensors, the robot may acquire state information of the robot, may detect (recognize) the surrounding environment and the object, may generate map data, may determine a travel route and a travel plan, may determine a response to user interaction, or may determine a necessary operation.

The robot may perform the above-described operations using a learning model composed of at least one artificial neural network (ANN). For example, the robot may recognize the surrounding environment and object using a learning model, and may determine a necessary operation using the recognized surrounding environment information or object information. Here, the learning model may be directly learned from the robot or learned from an external device such as an AI server.

In this case, whereas the robot may perform a necessary operation by directly generating a result using the learning model, the robot may also perform an operation by transmitting sensor information to an external device such as an AI server and receiving the resultant information generated thereby.

In order to perform autonomous driving, the movable object such as the robot may include a large number of sensors to recognize data of the surrounding situation. For example, the sensors may include a proximity sensor, an illumination sensor, an acceleration sensor, a magnetic sensor, a gyro sensor, an inertial sensor, an RGB sensor, an infrared (IR) sensor, a fingerprint recognition sensor, an ultrasonic sensor, an optical sensor, a microphone, a lidar, a radar, and the like.

Therefore, the robot may essentially include sensors, various input units, a wireless communication unit, and the like to collect data that may be learned by artificial intelligence, and may perform optimal operations by synthesizing various types of information. The learning processor for performing artificial intelligence may perform learning by being mounted in a controller embedded in the robot, may transmit the collected information to a server, may perform learning through the server, and may retransmit the learned result to the robot.

The robot may include a touchscreen or a button to receive a user input, and may receive a command by recognizing a user's voice. In order to convert a voice input signal into a character string, the processor may obtain information about the intention corresponding to the user input using at least one of a speech to text (STT) engine for converting a voice input into a character string and a natural language processing (NLP) engine for obtaining information about the intention of natural language.

In this case, at least one of the STT engine and the NLP engine may include an artificial neural network (ANN) trained by a machine learning algorithm. In addition, at least one of the STT engine and the NLP engine may be trained by the learning processor, may be trained by the learning processor of the AI server, or may be trained by distributed processing of the trained results.

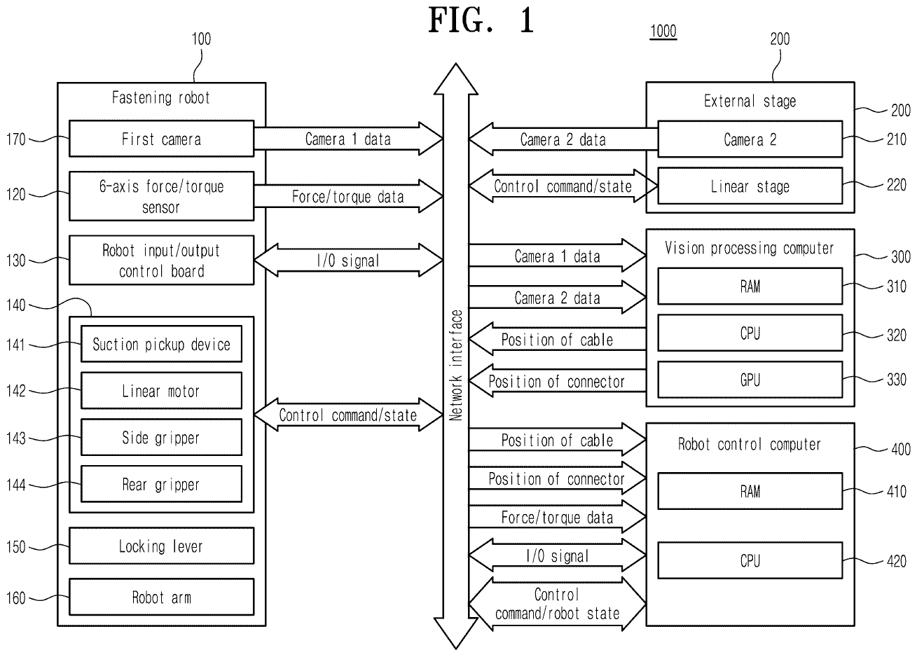

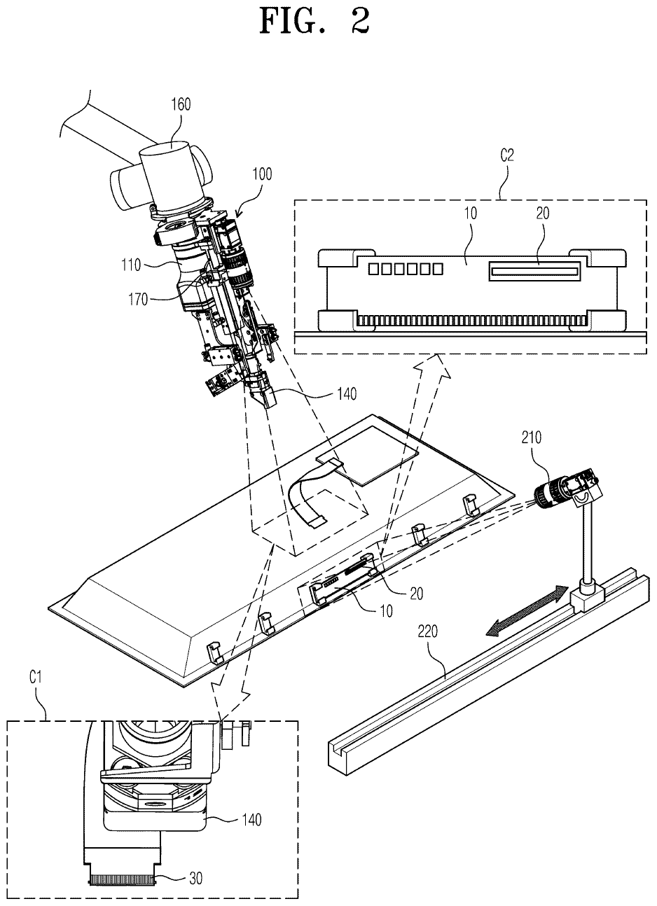

FIG. 1 is a block diagram for explaining a cable fastening system 1000 according to an embodiment of the present disclosure. FIG. 2 is a diagram showing the cable fastening system 1000 according to an embodiment of the present disclosure.

A cable such as a flexible printed circuit (FPC) or a flexible flat cable (FFC) may be used to connect printed circuit boards 10 to each other or to connect other electronic devices to the printed circuit board 10. For the convenience of explanation, it is referred to as a flat cable 30 hereinafter.

The printed circuit board 10 may include a connector 20 to which the flat cable 30 is connected. Referring to FIG. 1, the cable fastening system 1000 according to the present disclosure may include a fastening robot 100 that grips a cable and inserts it into the connector 20, an external stage 200 separately provided from the fastening robot 100, a vision processing computer 300 that determines the positions of the connector 20 and a connection portion 32 of the flat cable 30 based on images captured by a first camera 170 provided in the fastening robot 100 and a second camera 210 provided in the external stage 200, and a robot control computer 400 that controls each component of the fastening robot 100 based on the cable position and the position of the connector 20 detected by the vision processing computer 300.

Referring to FIG. 2, the fastening robot 100 according to the present disclosure may include a body 110 equipped with a gripper 140 for gripping the flat cable 30 at a lower end, and a robot arm 160 that is coupled to an upper side of the body 110 and is to be freely change the position and posture of the body 110.

The robot arm 160 may include a 6-axis force/torque sensor, detect the posture of the body 110 that changes due to the robot arm 160, and determine whether the flat cable 30 is fastened to the connector 20 through a slight pressure change when the flat cable 30 is connected to the connector 20.

The fastening robot 100 may include a robot input/output control board 130 that receives a worker's command from the robot control computer 400 and provides the state of the fastening robot 100 and the like to the robot control computer 400.

The fastening robot 100 may include a plurality of drivers and each driver may operate according to a control command of the robot control computer 400. The driver may largely include the gripper 140 and the robot arm 160 and may further include a locking lever 150 that engages a locking device 21 that fixes the flat cable 30 inserted into the connector 20.

The gripper 140 may include a suction pickup device 141 that attaches the flat cable 30 by applying negative pressure, a linear motor 142 that moves the suction pickup device 141 in a vertical direction, a side gripper 143 that grips the flat cable 30 from the left and right, and a rear gripper 144 that grips the flat cable 30 from a rear side.

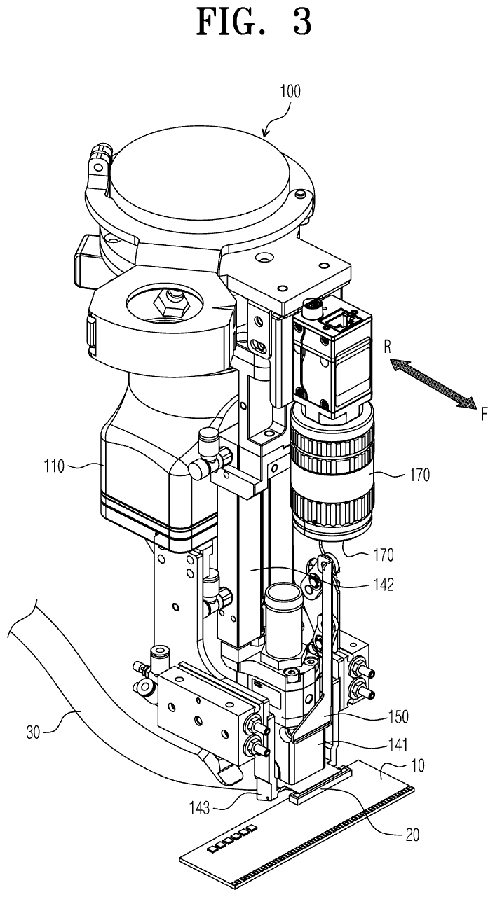

FIG. 3 is a diagram showing components of the fastening robot 100 excluding the robot arm 160, in which the robot arm 160 is coupled to an upper portion of the body 110, and the gripper 140 is located at a lower side of the body 110. When the flat cable 30 griped by the gripper 140 is fastened to the connector 20, a direction facing the connector 20 is called a front F and the opposite direction is called a rear R, and a vertical direction of the front-back direction may be called the left-right direction.

The suction pickup device 141 may be located at the lower portion of the body 110 and may suction the flat cable 30 through negative pressure. The fastening robot 100 may further include the linear motor 142 that drives the suction pickup device 141 in the up-down direction.

The linear motor 142 pulls out the suction pickup device 141 downward such that the suction pickup device 141 is not obstructed by the side gripper 143 or the rear gripper 144 when the suction pickup device 141 absorbs the flat cable 30. After adsorption, the linear motor 142 may move the suction pickup device 141 upward to position one end of the flat cable 30 between the side gripper 143 and the rear gripper 144.

The side gripper 143 and the rear gripper 144 may grip the flat cable 30 in place, but the suction pickup device 141 may include the first camera 170 to determine the position to some extent.

The first camera 170 may be positioned in the front direction of the body 110 to photograph the gripper 140. The gripper 140 may grip one end of the flat cable 30 recognized by the first camera 170 in which the connection portion 32 is located.

An image C1 in the box at the bottom of FIG. 2 is an image captured by the first camera 170, and only the flat cable 30 is captured by the first camera 170. A viewing angle of the first camera 170 of the fastening robot 100 is limited, and thus the connector 20 may not enter a field of view of a camera. Even if the connector 20 is within the field of view of the first camera 170, distortion may occur as the connector 20 is positioned at the end of a screen, making it difficult to detect the exact position of the connector 20.

Thus, the cable fastening system 1000 may include the second camera 210 that separately photographs the connector 20 from the fastening robot 100. The second camera 210 may photograph the connector 20 located on the printed circuit board 10 as shown in an upper right end C2 of FIG. 2.

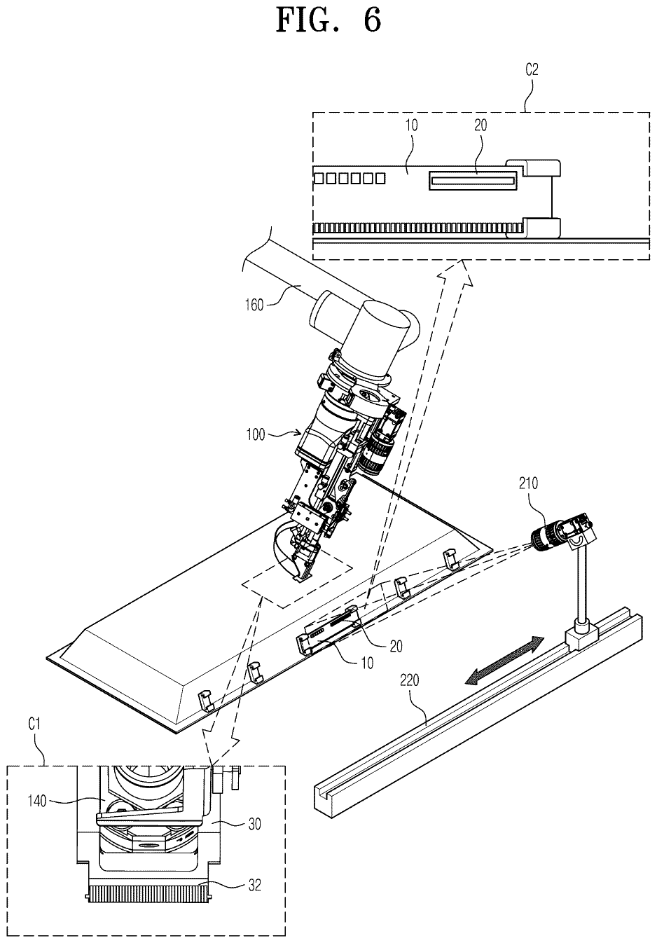

To detect the exact position of the connector 20, the cable fastening system 1000 may include a linear stage 220 that controls the position of the second camera 210 such that the connector 20 is located at the center of the screen. When the second camera 210 moves through the linear stage 220, the connector 20 may be positioned at the center of the screen as in C2 of FIG. 6.

The linear stage 220 according to the present disclosure is shown in a form that moves the second camera 210 only in a horizontal direction. A stage that controls the position of the second camera 210 in multiple directions may be used, but the equipment may become larger and the cost may increase.

Calculation of the position of the second camera 210 and the position of the connector 20 photographed by the second camera 210 may become complicated and the precision is reduced, and thus the present disclosure may use the linear stage 220 that moves in the horizontal direction.

The fastening robot 100 grips the flat cable 30 through the gripper 140 located at the lower portion of the body 110. After the position of the connection portion 32 of the flat cable 30 is identified by the first camera 170, the position of the body 110 may be changed by the robot arm 160.

The flat cable 30 according to the present disclosure extends from the printed circuit board 10 mounted on a back cover of a display device. The printed circuit board 10 mounted on the back cover is fixed in position, but the position of one end of the flat cable 30 is not fixed, and thus is not placed exactly in the designated position. The first camera 170 may detect the position of the connection portion 32 of the first camera 170 by moving the robot arm 160.

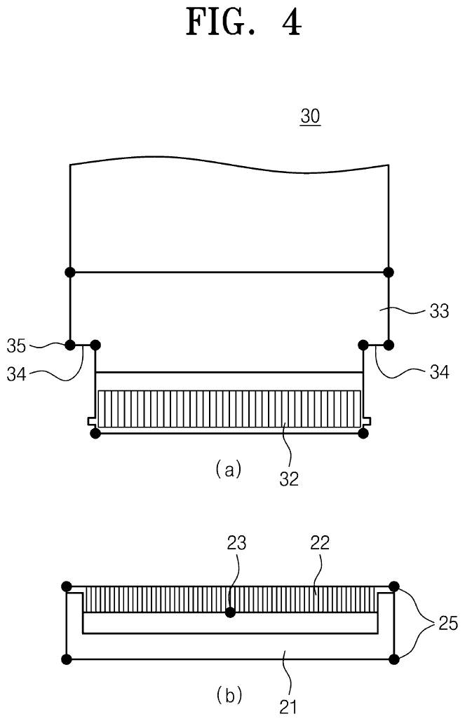

FIG. 4 is a diagram for explaining a method of recognizing the flat cable 30 and the connector 20 by the first camera 170 and the second camera 210 of the cable fastening system 1000 according to an embodiment of the present disclosure.

(a) of FIG. 4 shows one end of the flat cable 30 photographed by the first camera 170, and the one end of the flat cable 30 may include the connection portion 32 and a cable holder 33 to facilitate insertion and removal of the flat cable 30 while protecting the connection portion 32.

The cable holder 33 may have one end attached to the flat cable 30 and the other end spaced apart from the flat cable 30, and the rear gripper 144 described below may be inserted between the cable holder 33 and the flat cable 30 and may grip the flat cable 30.

A signal line connected to the connection portion 32 located at one end of the flat cable 30 extends in an extension direction of the flat cable 30, and the other end of the flat cable 30 may also include the connection portion 32. One end of the flat cable 30 may include a step portion 34 for insertion into the connector 20, and the flat cable 30 is widened in a width direction at the end at which the connection portion 32 is located and includes the step portion 34.

That is, one end of the flat cable 30 is narrower than the other portion of the flat cable 30 by the size of the step portion 34. The first camera 170 may recognize the corners of each component as key points 25 and 35 to distinguish the connection portion 32, the cable holder 33, and the step portion 34.

One end of the flat cable 30 at which the connection portion 32 is located, a line connecting the pair of step portions 34, and the end of the cable holder 33 may form parallel lines. Machine learning may be used to more accurately extract the positions of the flat cable 30 and the connector 20 from images.

(b) of FIG. 4 shows the connector 20 recognized by the second camera 210. The connector 20 may include an insertion portion having a plurality of terminals 22 positioned therein, and when one end of a flat cable 30 is inserted into the insertion portion, the flat cable 30 may come into contact with the connection portion 32 and the terminal 22 of the connector 20, and signals may be transmitted and received through the flat cable 30.

By recognizing the four corners of the connector 20 as the key points 25 and 35, a box 22 indicating the position of the connector 20 may be set, and a central point 23 of the connector 20 may be determined based thereon. The linear stage 220 may move the second camera 210 such that the central point 23 of the connector 20 is located at the center of the screen of the second camera 210.

The vision processing computer 300 may include RAM and CPU and may further include a GPU 330 to receive and process data from the first camera 170 and the second camera 210.

The robot control computer 400 may mean a data processing device built into hardware that has a physically structured circuit to perform a function expressed by a code or command included in a program.

An example of a data processing device built into hardware may can include processing devices such as a microprocessor, a central processing unit (CPU), a processor core, a multiprocessor, an application-specific integrated circuit (ASIC), a field programmable gate array (FPGA), and a random access memory (RAM).

The robot control computer 400 may control drivers 140, 150, and 160 of the fastening robot 100 based on the position of the cable recognized by the vision processing computer 300, the position of the connector 20, the posture of the body 110 detected by a 6-axis force/torque sensor 120, and the pressure applied to the gripper 140.

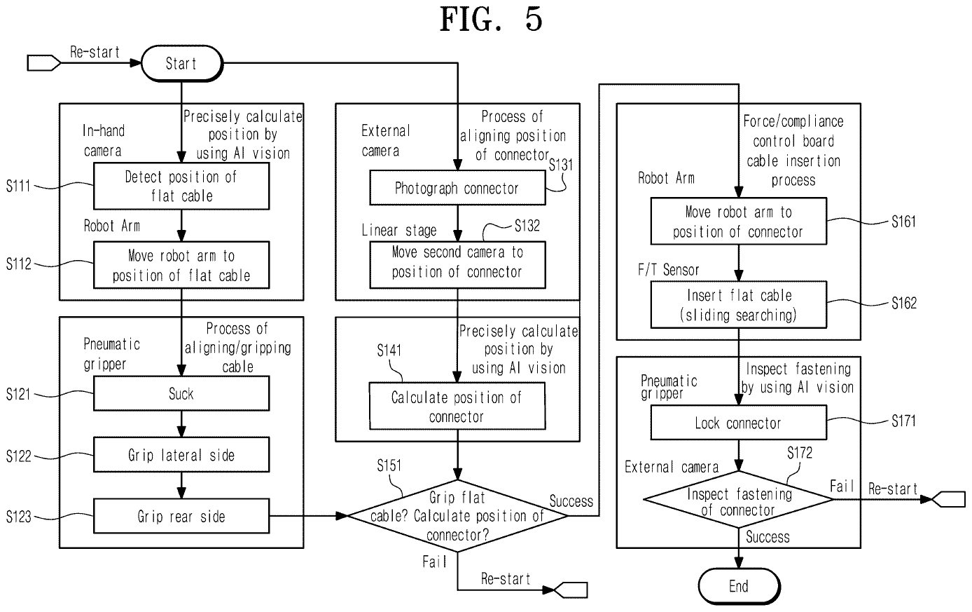

FIG. 5 is a flowchart illustrating a cable fastening method according to an embodiment of the present disclosure. According to the flow of FIG. 5, the operation of the cable fastening system 1000 according to an embodiment of the present disclosure will be sequentially described with reference to FIGS. 6 to 18.

First, in a state as shown in FIG. 2, the flat cable 30 and the printed circuit board 10 may be positioned at the lower portion of the fastening robot 100. In the case of a given product, the position of the flat cable 30 and the position of the printed circuit board 10 may be arranged in relatively similar positions, and thus the second camera 210 and the linear stage 220 may also be arranged to photograph the connector 20 in consideration of the product.

The first camera 170 photographs the flat cable 30, and the vision processing computer 300 detects the precise position of the cable by using an AI vision (S111). The robot control computer 400 may move the body 110 such that the suction pickup device 141 is located at the upper side of one end of the flat cable 30 (S112).

The suction pickup device 141 applies negative pressure to suck the cable (S121). FIG. 6 is a diagram illustrating a state in which the cable fastening system 1000 grips a cable according to an embodiment of the present disclosure. In operation S112, the fastening robot moved in one direction of the flat cable 30 is in a different position from that in FIG. 2, and the flat cable 30 is coupled to the suction pickup device 141.

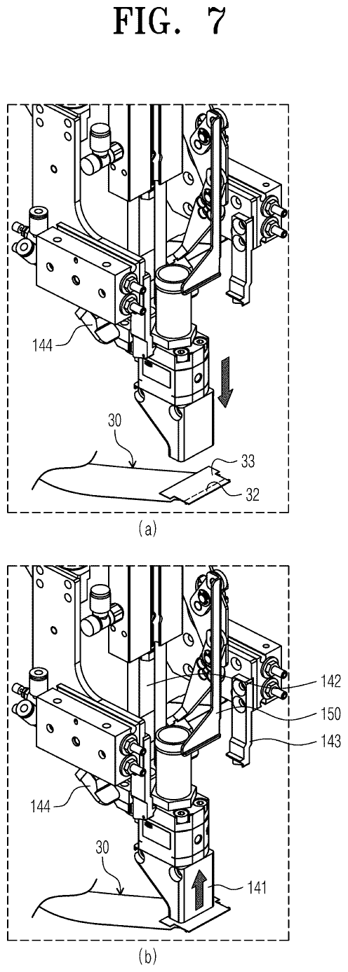

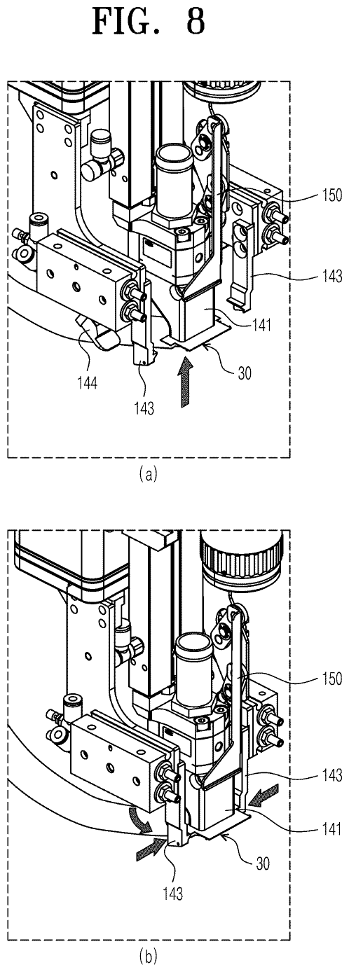

FIG. 7 and FIG. 8 are diagrams illustrating a process in which the cable fastening system 1000 absorbs and grips a cable according to an embodiment of the present disclosure. (a) of FIG. 7 illustrates operation S112 of moving the body 110 such that the suction pickup device 141 is located at the upper side of one end of the flat cable 30, and (b) of FIG. 7 illustrates a state S121 in which the flat cable 30 is suctioned.

(a) of FIG. 8 is a diagram showing a state in which the position of the suction pickup device 141 is moved upward by using the linear motor 142. When the suction pickup device 141 is arranged as in (a) of FIG. 8, the side gripper 143 and the rear gripper 144 interfere with each other, making it difficult to approach the flat cable 30.

Therefore, the linear motor 142 may pull out the suction pickup device 141 downward as shown in (a) of FIG. 7, and then suction the flat cable 30 as shown in (b), and then move to a position at which the side gripper 143 and the rear gripper 144 may grip as shown in (a) of FIG. 8.

As shown in (b) of FIG. 8, the side gripper 143 and the rear gripper 144 grip the lateral and rear sides of the flat cable 30 attached to the suction pickup device 141 (S122 and S123 in FIG. 5).

The side gripper 143 grips the left and right sides of the flat cable 30. The flat cable 30 is thin, has a small width on the left and right sides, and is flexible, and when the side gripper 143 applies too much force, the flat cable 30 may bend.

To prevent the flat cable 30 from bending, the vision processing computer 300 may calculate the width of the flat cable 30 and the robot control computer 400 may determine the driving amount of the side gripper 143.

The suction pickup device 141 is in a state of sucking and holding the flat cable 30, and thus when a space between the pair of side grippers 143 is narrowed, the longitudinal direction of the flat cable 30 may be aligned with the front-back direction of the fastening robot 100.

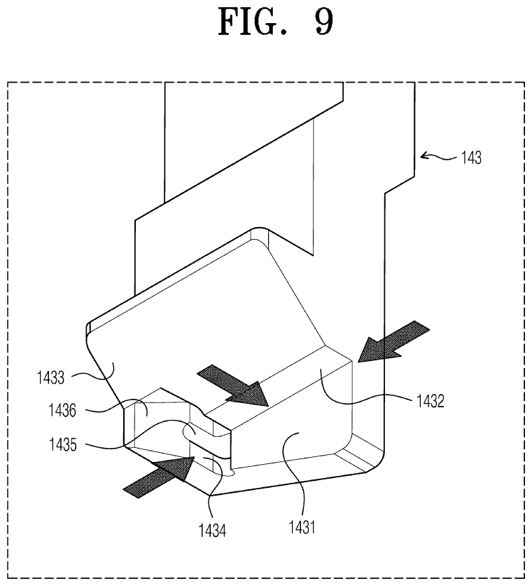

FIG. 9 is a diagram showing a lower portion of the side gripper 143 of the cable fastening system 1000 according to an embodiment of the present disclosure.

The side gripper 143 may include a side wall portion 1431 that is in contact with the side of the flat cable 30 and an upper surface portion 1432 that extends vertically from the upper portion of the side wall portion 1431 and is in contact with the upper surface of the flat cable 30. The side wall portion 1431 and the upper surface portion 1432 may align the vertical and left-right positions of the flat cable 30.

The side gripper 143 may include a first inclined guide 1433 located at the upper portion of the side wall portion 1431 and extending toward the opposing side gripper 143. When the side of the flat cable 30 touches the first inclined guide, the flat cable 30 may slide along the first inclined guide 1433 and move to the side wall portion 1431.

The flat cable 30 includes the step portion 34 having a width increasing in a direction toward the other end from the connection portion 32. The pair of side grippers 143 may extend vertically from the front of the side wall portion 1431 and include a front portion that is in contact with the step portion 34 of the flat cable 30. The front portion 1434 has an accommodation groove 1435 such that the vertical movement of the step portion 34 may also be restricted.

The side gripper 143 may include a second inclined guide 1436 extended from the front of the accommodation groove 1435. When a gap between the side grippers 143 narrows and the edge of the step portion 34 is in contact with the second inclined guide 1436, the edge of the step portion 34 moves along the second inclined guide 1436. The flat cable 30 may be pushed backward such that the step portion 34 may be inserted into the accommodation groove 1435.

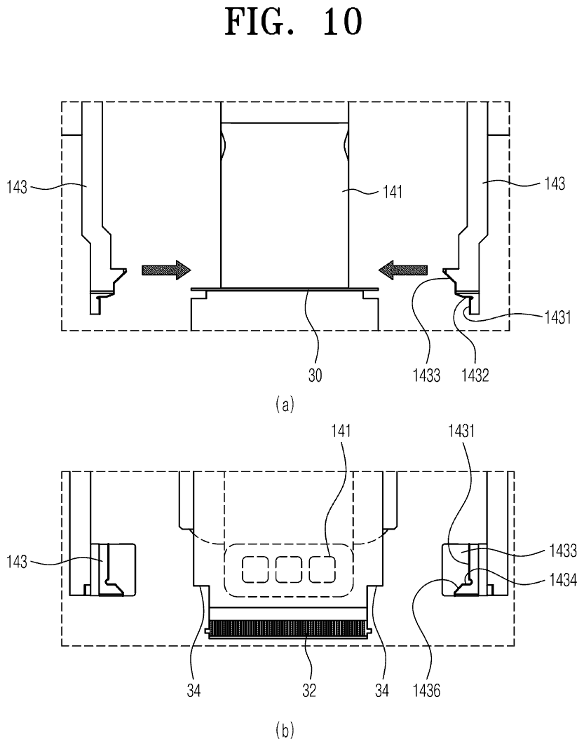

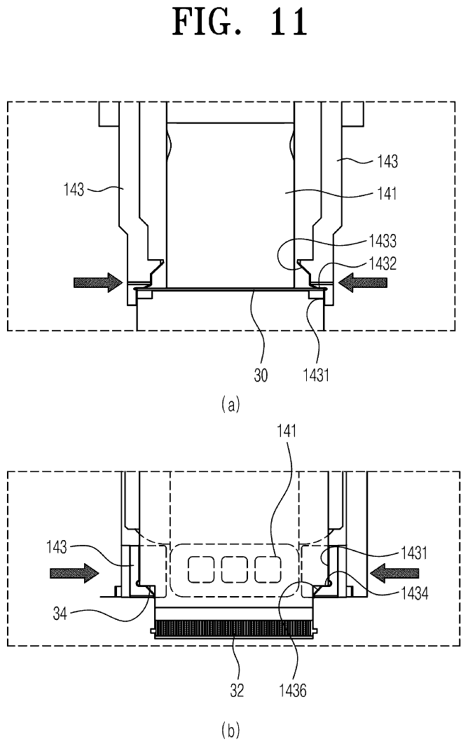

FIG. 10 and FIG. 11 are diagrams illustrating the operation of the side gripper 143 of the cable fastening system 1000 according to an embodiment of the present disclosure. FIG. 10 shows a state in which the side grippers 143 are spaced apart, and FIG. 11 shows a state in which the side grippers 143 are close.

As shown in (b) of FIG. 10, the flat cable 30 includes the step portion 34. The lower shape of the side gripper 143 may be configured such that the width of the second inclined guide and the front portion 1434 is smaller than the width of the step portion 34.

As seen from (b) of FIG. 11, the side wall portion 1431 of the side gripper 143 and the side surface of the flat cable 30 are aligned with the front portion 1434 of the side gripper 143 and the step portion 34 of the flat cable 30.

Referring to (a) of FIG. 11, the upper surface portion 1432 of the side gripper 143 and an upper surface of the flat cable 30 are in contact and aligned. The cable holder 33 is located on the upper surface of one end of the flat cable 30, and thus a portion that is absorbed by the suction pickup device 141 is the cable holder 33.

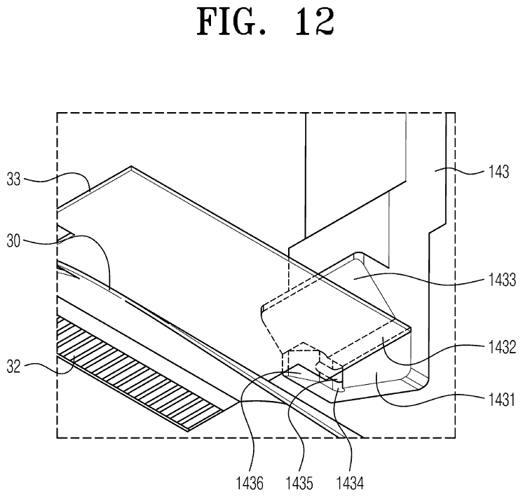

FIG. 12 is a perspective view showing a state in which the flat cable 30 is aligned to the side gripper 143 of the cable fastening system 1000 according to an embodiment of the present disclosure. The extended portion of the cable holder 33 may not be coupled to the flat cable 30 and may be opened.

As described above, the first and second inclined surfaces may align the left and right positions, vertical positions, and forward positions of the flat cable 30. However, when the flat cable 30 is sucked into the suction pickup device 141 to be positioned further back than the fixed position, the step portion 34 may not be inserted into the accommodation groove 1435, and the front portion 1434 and the step portion 34 may be spaced apart.

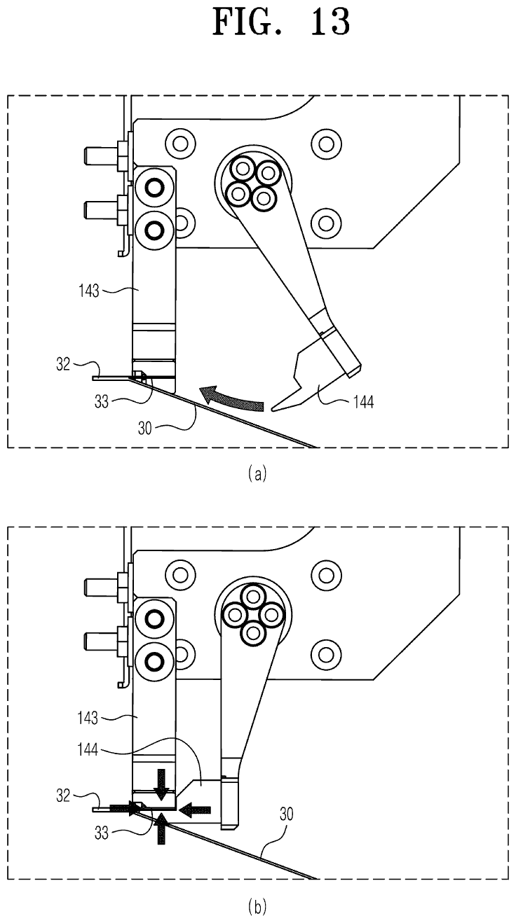

The cable fastening system 1000 may further include the rear gripper 144 that applies a force to push from the rear such that the step portion 34 of the flat cable 30 is inserted into the accommodation portion. FIG. 13 is a diagram illustrating the operation of the rear gripper 144 of the cable fastening system 1000 according to an embodiment of the present disclosure.

The rear gripper 144 is a lever-shaped gripper that is located at the rear of the side gripper 143 and rotates within a predetermined angle range as shown in FIG. 13.

The rear gripper 144 includes a protrusion that protrudes forward at the bottom, and the protrusion provides a force to push the flat cable 30 forward while being inserted between the cable holder 33 and the signal line of the flat cable 30. The step portion 34 of the flat cable 30 is in close contact with the accommodation groove 1435, and the position alignment of the flat cable 30 may be completed.

Referring to FIG. 5, the second camera 210 located on the external stage 200 photographs the second camera 210 and detects the position of the connector 20 (S131). When the connector 20 is not located at the center of a viewing angle of the second camera 210 as in C2 of FIG. 2, the linear stage 220 may move the second camera 210 such that the connector 20 is located at the front of the second camera 210 (S132).

When the connector 20 is positioned in front of the second camera 210, distortion is minimized such that the vision processing computer 300 may calculate the exact position of the connector 20 (S141).

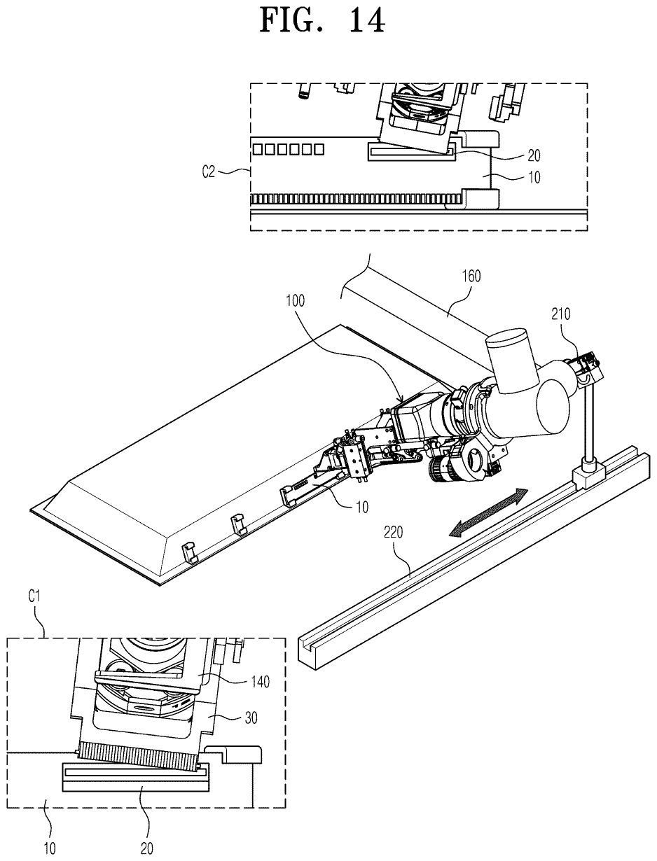

When gripping of the flat cable 30 is completed and the position calculation of the connector (20) is completed (S151), the robot arm 160 moves such that the connection portion 32 of the flat cable 30 is positioned at the position of the connector 20 (S161). FIG. 14 is a diagram showing a state in which the cable fastening system 1000 inserts a cable into the connector 20 according to an embodiment of the present disclosure, and the robot arm 160 is moved toward the connector 20.

The robot arm 160 may freely change the posture of the body 110 of the fastening robot 100. In operation S162 of inserting the flat cable 30 into the connector 20, the robot arm 160 is moved to inert the flat cable 30 into the connector 20. When the robot arm 160 moves vertically in an insertion hole of the connector 20, the insertion hole of the connector 20 and the position of the flat cable 30 need to be exactly aligned. If there is even a slight misalignment, the insertion may not occur, and thus the robot arm needs to move back and forth several times.

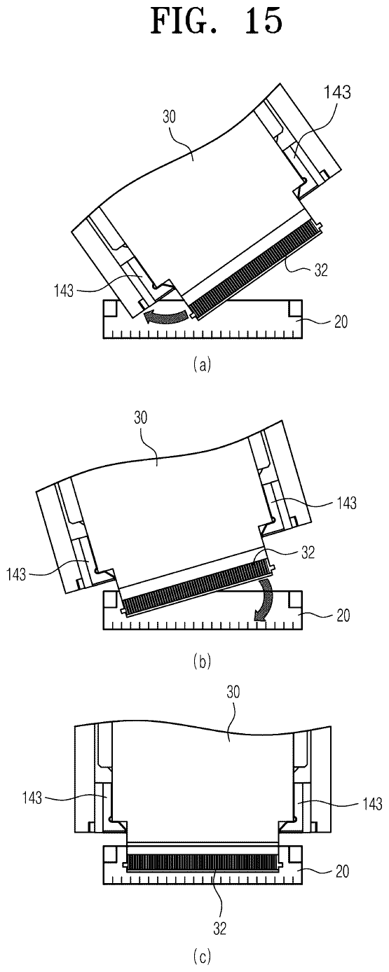

As the number of failures increases, a time required to insert the flat cable 30 into the connector 20 increases, and the connection portion 32 of the flat cable 30 may be damaged. Accordingly, the present disclosure may utilize a fastening method through the sliding and rotational movement of the robot arm 160. FIG. 15 is a diagram illustrating a process of inserting the flat cable 30 of the cable fastening system 1000 into the connector 20 according to an embodiment of the present disclosure.

As shown in (a) of FIG. 15, one end of the flat cable 30 and the connector 20 are not arranged parallel, but are arranged obliquely, and one side of the connection portion 32 of the flat cable 30 is inserted into the connector 20. As shown in (b) of FIG. 15, when the flat cable 30 slides in one direction and the flat cable 30 is rotated such that the other side of the connection portion 32 is inserted into the connector 20, the connection portion 32 of the flat cable 30 may be completely inserted into the connector 20 as shown in (c) of FIG. 15.

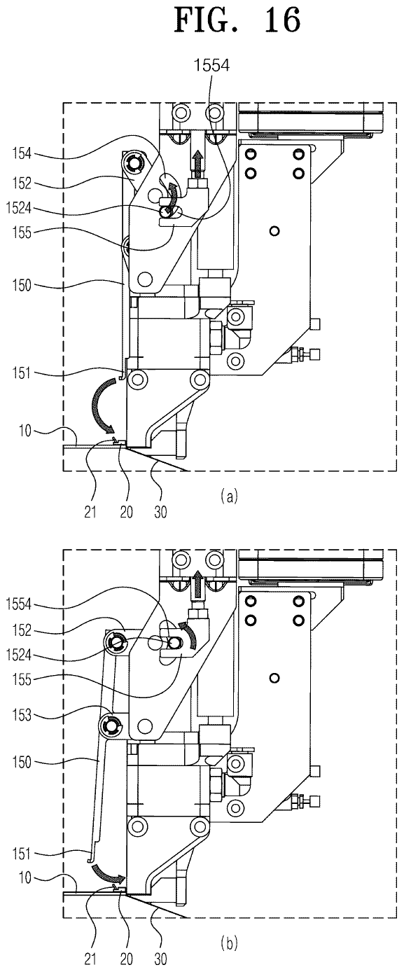

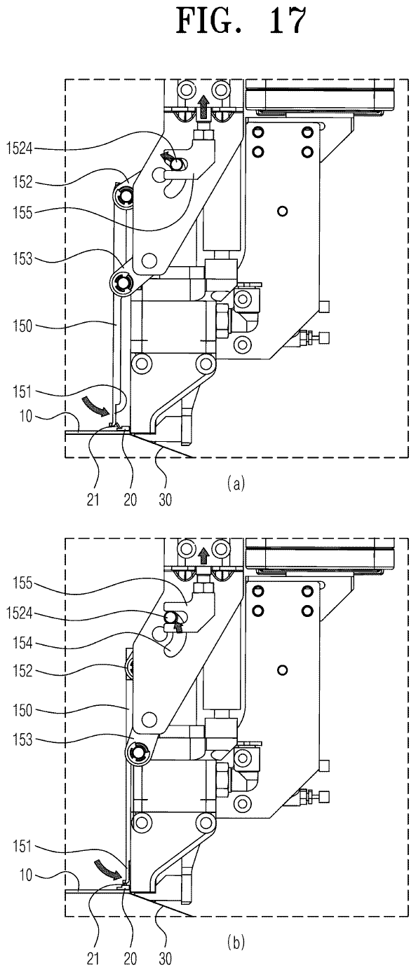

FIG. 16 and FIG. 17 are diagrams illustrating the operation of the cable locking lever 150 of the cable fastening system 1000 according to an embodiment of the present disclosure. When the insertion of the flat cable 30 into the connector 20 is completed, the cable may be fixed with the locking device 21 of the connector 20 (S162).

The locking device 21 may help to maintain a contact state between the terminal 22 of the connector 20 and the connection portion 32 of the flat cable 30, and thus connection between the connector 20 and the flat cable 30 may be made stably.

The connector 20 may include the locking device 21 that presses the flat cable 30 to prevent the flat cable 30 from being detached from the connector 20. The locking device 21 may be located in front of the connector 20, and the locking lever 150 that fastens the locking device 21 may be located in front of the gripper 140.

A lower end 151 of the locking lever 150 is positioned apart from the connector 20 when the cable is fastened to the connector as shown in (a) of FIG. 16, and a lower end 151 of the locking lever 150 moves in a parabolic shape to push and connect the locking device 21.

The locking lever 150 may be connected to the body 110 through a drive link 152 on an upper side, and an angle formed by the link with the locking lever 150 and the body 110 may be changed, thereby changing the position of the locking lever 150. The drive link 152 may move in a curved manner with one end connected to the locking lever 150 centered on a part that is rotatably coupled to the body 110.

When the other end of the drive link 152 is moved in an opposite direction to the movement direction of the locking lever 150, the locking lever 150 is driven. A lever driver that applies force to the drive link 152 may include a locking block 155 that moves vertically, and may include a link slot 1554 that extends horizontally to the locking block 155.

A link protrusion 1524 located at the other end of the drive link 152 is inserted into the link slot 1554, and when the locking block 155 moves, the link protrusion 1524 also moves along the locking block 155. However, the drive link 152 rotates, and thus the horizontal position of the link protrusion 1524 may change, and the link slot 1554 may induce vertical movement while allowing horizontal movement of the link protrusion 1524. The body 110 may further include a curved slot 154 that guides the curved movement of the link protrusion 1524.

As one end of the drive link 152 moves in a curve, an upper side of the locking lever 150 also moves in a curve accordingly. When the drive link 152 and the locking lever 150 are rotatably connected and only one drive link 152 is connected, it is difficult for the locking lever 150 to apply force to the locking device 21.

Accordingly, the present disclosure may further include a guide link 153 connected to the body 110 on the lower side of the drive link 152, and the guide link 153 is connected to the locking lever 150 such that an angle with respect to the drive link 152 does not change when the locking lever 150 comes into contact with the locking device 21.

The locking lever 150 descends as the locking block 155 rises, but also moves forward and backward along with the descending movement by the drive link 152. As shown in (b) of FIG. 16, the locking lever 150 protrudes forward and descends, then moves backward as shown in (a) of FIG. 17, comes into contact with the locking device 21, and as shown in (b) of FIG. 17, the locking lever 150 presses the locking device 21 while being pressed against the body 110 again, thereby fixing the flat cable 30 to the connector 20 (S171).

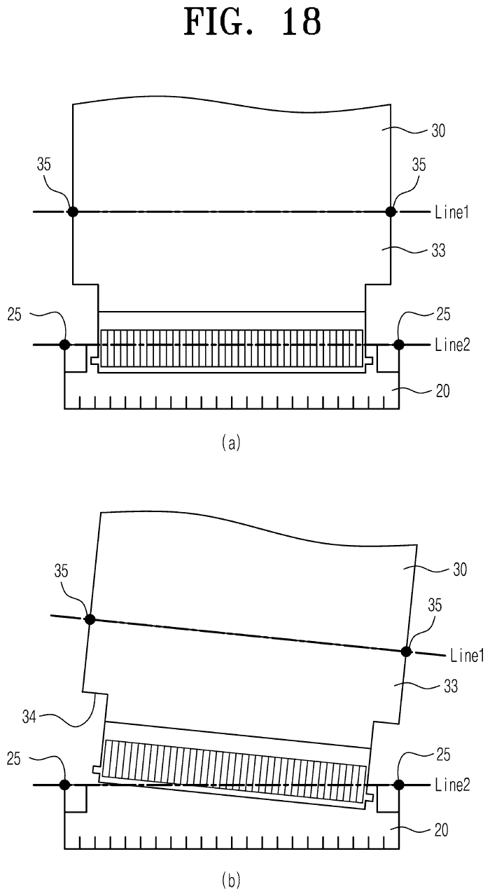

FIG. 18 is a diagram illustrating a method of evaluating a state in which a flat cable of the cable fastening system 1000 is fastened to the connector 20, according to an embodiment of the present disclosure.

The conventional cable fastening method inserts the cable by moving vertically into the insertion hole of the connector 20. In the conventional cable fastening method, when the flat cable 30 is fully inserted into the insertion hole, completion of fastening may be determined through a slight pressure difference detected by the robot.

However, completion of fastening is determined using a small pressure difference, and thus there is a problem that errors may occur and accuracy is low. According to the present disclosure, whether the flat cable 30 is correctly inserted into the connector 20 may be determined based on an image captured by a camera to additionally inspect fastening of the connector 20 (S172 in FIG. 5).

FIG. 18 is a diagram illustrating a method of evaluating a state in which the flat cable 30 of the cable fastening system 1000 is fastened to the connector 20, according to an embodiment of the present disclosure. Referring to FIG. 18, the second camera 210 may photograph a state after the flat cable 30 is connected to the connector 20.

The vision processing computer 300 may detect a first reference line Line 1 connecting an end of the cable holder 33 of the flat cable 30 and a second reference line Line 2 connecting the key point of the connector 20.

When the first reference line Line 1 and the second reference line Line 2 are parallel as in (a) of FIG. 18, the connection state of the flat cable 30 may be determined to be normal. However, when the first reference line Line 1 and the second reference line Line 2 are not parallel as in (b) of FIG. 18, the connection state may be determined to be poor and the connection may be reattempted.

As described above, the cable fastening system 1000 according to the present disclosure may quickly fasten a cable to the connector 20 on a board.

The cable fastening system 1000 according to the present disclosure may have an advantage of improving the accuracy of cable fastening by identifying the exact fastening position through image analysis.

The cable fastening system 1000 according to the present disclosure may reduce failure of the cable to be fastened to the connector 20 and prevent the connection portion 32 of the cable from being damaged in the event of a fastening failure.

The above detailed description is not to be construed as limiting in any respect and should be considered exemplary. The scope of the disclosure is to be determined by a reasonable interpretation of the appended claims, and all changes within the equivalents of the disclosure are included in the scope of the disclosure.

1. A cable fastening system comprising:
a body;
a gripper located at a lower portion of the body and gripping one end at which a connection portion of a flat cable is located;
a robot arm coupled to an upper side of the body and inserting one end of the flat cable into a connector; and
a controller configured to control the gripper and the robot arm,
wherein the robot arm inserts one side of the connection portion of the flat cable into the connector, slide the flat cable in a direction of one side of the connection portion, and then rotate the body such that the connection portion of the flat cable and the connector are arranged parallel to each other.

2. The cable fastening system of claim 1, wherein the gripper includes a pair of side grippers that have a gap that narrows in right and left directions of the flat cable and grip the flat cable, and
the pair of side grippers include:
a side wall portion positioned laterally of the flat cable; and
an upper surface portion extending vertically from an upper portion of the side wall portion and in contact with an upper surface of the flat cable.

3. The cable fastening system of claim 2, wherein the pair of side grippers include a first inclined guide positioned on an upper portion of the side wall portion and extending toward the opposing side gripper.

4. The cable fastening system of claim 2, wherein the flat cable includes a step portion having a width that increases in another-end direction from the connection portion, and
the pair of side grippers include:
a front portion having an accommodation groove extending vertically from a front of the side wall portion and in contact with the step portion; and
a second inclined guide extending toward the flat cable from a front of the accommodation groove.

5. The cable fastening system of claim 4, wherein the flat cable includes a cable holder extending in another-end direction from the connection portion, and
a rear gripper inserted between the cable holder and the flat cable such that the step portion of the flat cable is inserted into the accommodation groove is provided.

6. The cable fastening system of claim 1, wherein the gripper includes a suction pickup device that provides negative pressure to suck the flat cable.

7. The cable fastening system of claim 6, wherein the gripper includes a linear motor that drives the suction pickup device up and down.

8. The cable fastening system of claim 1, further comprising a first camera positioned on the body and configured to photograph the gripper,
wherein the controller recognizes a position of the connection portion of the flat cable based on an image captured by the first camera and controls the robot arm such that the connection portion is inserted into the connector.

9. The cable fastening system of claim 8, wherein the flat cable includes a step portion having a width that increases in another-end direction from the connection portion; and
a cable holder extending in the other-end direction from the connection portion, and
the controller recognizes the connection portion of the flat cable, the step portion, and the cable holder by designating a corner of at least one of one end of the flat cable, the step portion and the cable holder as a key point.

10. The cable fastening system of claim 9, wherein the controller determines that insertion of the flat cable into the connector is performed normally when one of a straight line connecting key points of the step portion of the flat cable or a straight line connecting key points of the cable holder is parallel to the insertion portion of the connector.

11. The cable fastening system of claim 1, further comprising a second camera configured to photograph the connector and detect a position of the insertion portion of the connector,
wherein the controller controls the robot arm such that the connection portion of the flat cable is inserted into the insertion portion of the connector.

12. The cable fastening system of claim 11, further comprising a linear stage configured to change a horizontal position of the second camera,
wherein the controller controls the linear stage such that a horizontal center of the insertion portion is located at a center of a viewing angle of the second camera.

13. The cable fastening system of claim 1, further comprising:
a drive link rotatably coupled to the body;
a locking lever having an upper portion coupled to one end of the drive link and located in front of the gripper; and
a lever driver that moves another end of the drive link,
wherein during driving of the locking lever, a lower end of the locking lever pushes a locking device of the connector and presses the flat cable.

14. The cable fastening system of claim 13, further comprising a guide link located at a lower portion of the drive link and located between the body and the locking lever,
wherein the lower end of the locking lever moves in a parabolic shape.

15. The cable fastening system of claim 13, wherein the lever driver includes a link slot extending horizontally formed therein and a locking block moving vertically, and
da link protrusion protruding from an upper end of the drive link is inserted into the link slot and is changed in position within the link slot when the locking block moves.
